(19) United States
(12) Patent Application Publication
(10) Pub. No.: US 2026/0237031 A1
(43) Pub. Date: Aug. 13, 2026

(54) METHOD OF IMAGE GENERATION, ELECTRONIC DEVICE, AND STORAGE MEDIUM

(71) Applicant: Beijing Zitiao Network Technology Co., Ltd., Beijing (CN)

(72) Inventors: Mengtian LI, Beijing (CN); Jinshu CHEN, Beijing (CN); Wanquan FENG, Beijing (CN); Bingchuan LI, Beijing (CN); Fei DAI, Beijing (CN); Songtao ZHAO, Beijing (CN)

(21) Appl. No.: 19/533,939

(22) Filed: Feb. 9, 2026

(30) Foreign Application Priority Data
Feb. 7, 2025 (CN) 202510138118.9

(51) Int. Cl. G06T 5/70; G06T 5/60; G06V 10/77; G06V 10/82

(52) U.S. Cl. CPC G06T 5/70; G06T 5/60; G06V 10/7715; G06V 10/82; G06T 2207/20084

(57) ABSTRACT

The present disclosure provides a method of image generation, an electronic device, and a storage medium. The method includes: determining, by using a parameter prediction network and based on an original image, a target parameter corresponding to a target object in the original image; configuring, by using the target parameter, a parameter in a feature extraction network; extracting, by using the configured feature extraction network, a feature of the target object from the original image; and performing, by using a noise reduction network and based on the feature of the target object in the original image, denoising processing on a preset noise image to obtain a target image, where the target image includes a derived object, and an exclusive feature of the derived object is consistent with an exclusive feature of the target object.

### CROSS-REFERENCE TO RELATED APPLICATION

The present disclosure claims priority of the Chinese Patent Application No. 202510138118.9 filed on February 7, 2025, the disclosure of which is incorporated herein by reference in its entirety as part of the present application.

### TECHNICAL FIELD

The present disclosure relates to a method of image generation, an electronic device, and a storage medium.

### BACKGROUND

With the development of artificial intelligence technologies, especially the application of deep learning in the field of image processing, a technique of performing image generation based on a guide image has been realized. In many application scenarios of image generation technologies, portrait preservation is a very important scenario. Portrait preservation aims to ensure that during the image generation process, the identity features and facial details of a specific person may be accurately and consistently preserved, so that the generated image is highly similar to the original person, and even the two may be regarded as the same person to some extent.

### SUMMARY

The present disclosure provides a method of image generation, an image generation model used to implement the method of image generation includes a parameter prediction network, a feature extraction network, and a noise reduction network, both the parameter prediction network and the noise reduction network are connected to the feature extraction network, and the method includes:

determining, using the parameter prediction network and based on an original image, a target parameter (for example, a first parameter) corresponding to a target object (for example, a first object) in the original image;

configuring, using the target parameter, a parameter in the feature extraction network;

extracting, using the configured feature extraction network, a feature of the target object from the original image; and

performing, using the noise reduction network and based on the feature of the target object in the original image, denoising processing on a preset noise image to obtain a target image, where the target image includes a derived object, and an exclusive feature of the derived object is consistent with an exclusive feature of the target object.

The present disclosure further provides an apparatus of image generation, an image generation model used to implement the method of image generation includes a parameter prediction network, a feature extraction network, and a noise reduction network, both the parameter prediction network and the noise reduction network are connected to the feature extraction network, and the apparatus includes:

a parameter prediction module, configured to determine, using the parameter prediction network and based on an original image, a target parameter corresponding to a target object in the original image;

a configuration module, configured to configure, using the target parameter, a parameter in the feature extraction network;

a feature extraction module, configured to extract, using the configured feature extraction network, a feature of the target object from the original image; and

an image generation module, configured to perform, using the noise reduction network and based on the feature of the target object in the original image, denoising processing on a preset noise image to obtain a target image, where the target image includes a derived object, and an exclusive feature of the derived object is consistent with an exclusive feature of the target object.

The present disclosure further provides an electronic device, the electronic device includes:

one or more processors;

a storage apparatus configured to store one or more programs,

when the one or more programs are executed by the one or more processors, the one or more processors are caused to implement the method of image generation as described above.

The present disclosure further provides a computer-readable storage medium having a computer program stored thereon, and when the program is executed by a processor, the method of image generation as described above is implemented.

### BRIEF DESCRIPTION OF DRAWINGS

The drawings herein, which are incorporated in and constitute a part of this specification, illustrate embodiments consistent with the present disclosure and, together with the description, serve to explain the principles of the present disclosure.

In order to more clearly describe the technical solutions in embodiments of the present disclosure or in the prior art, the following briefly introduces the drawings required for describing the embodiments or the prior art. Apparently, a person of ordinary skill in the art may still derive other drawings from these drawings without creative efforts.

FIG. 1 is a schematic diagram of an image generation model according to an embodiment of the present disclosure;

FIG. 2 is a flowchart of a method of image generation according to an embodiment of the present disclosure;

FIG. 3 is a schematic diagram of an image generation model according to an embodiment of the present disclosure;

FIG. 4 is a flowchart of a method of image generation according to an embodiment of the present disclosure;

FIG. 5 is a schematic diagram of a structure of an apparatus of image generation according to an embodiment of the present disclosure; and

FIG. 6 is a schematic diagram of a structure of an electronic device according to an embodiment of the present disclosure.

### DETAILED DESCRIPTION

In order to understand the above objectives, features, and advantages of the present disclosure more clearly, the solutions of the present disclosure are further described below. It should be noted that the embodiments of the present disclosure and the features in the embodiments may be combined with each other without conflict.

Many specific details are set forth in the following description to facilitate a full understanding of the present disclosure, but the present disclosure may also be implemented in other ways different from those described herein. Apparently, the described embodiments are part of the embodiments of the present disclosure, rather than all of them.

In practical applications, it usually requires the user to provide a plurality of portrait images of the same person, and then use these image data to perform model training to construct a portrait preservation model exclusive to the person. Subsequently, the portrait preservation model exclusive to the person may be used to perform image generation work for the person. This training process usually takes a long time and requires high device performance, which seriously restricts the application and promotion of the portrait preservation technology.

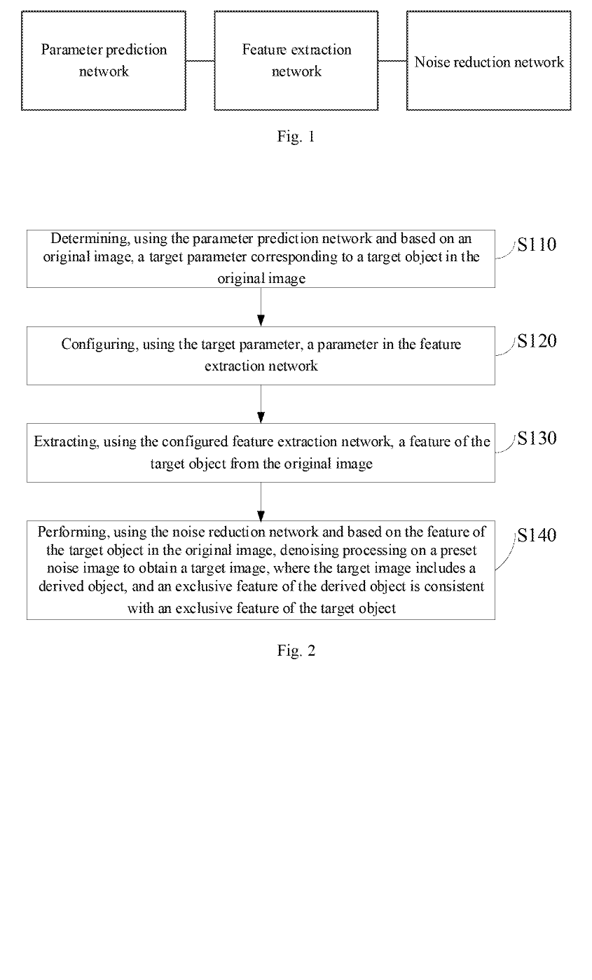

FIG. 1 is a schematic diagram of an image generation model according to an embodiment of the present disclosure. FIG. 2 is a flowchart of a method of image generation according to an embodiment of the present disclosure. This embodiment may be applied to a case where image generation is performed in a client. The method may be performed by an apparatus of image generation, and the apparatus may be implemented in a form of software and/or hardware and may be configured in an electronic device, such as a terminal, specifically including but not limited to a smartphone, a palmtop computer, a tablet computer, a wearable device with a display screen, a desktop computer, a notebook computer, an all-in-one computer, a smart home device, etc. Alternatively, this embodiment may be applied to a case where image generation is performed in a server. The method may be performed by an apparatus of image generation, and the apparatus may be implemented in a form of software and/or hardware and may be configured in an electronic device, such as a server.

Referring to FIG. 1, the image generation model may implement the method of image generation provided in the present application. The image generation model includes a parameter prediction network, a feature extraction network, and a noise reduction network. Both the parameter prediction network and the noise reduction network are connected to the feature extraction network.

According to FIG. 2, the method may specifically include the following steps.

S110: determining, using the parameter prediction network and based on an original image, a target parameter (for example, a first parameter) corresponding to a target object (for example, a first object) in the original image.

The original image may be, for example, an image provided to the image generation model during a process of using the image generation model, which is used to guide the image generation model to perform image generation. The original image includes the target object. The target object is an object that needs to be focused on or expected to be highlighted in the original image, and is an object whose exclusive feature needs to be preserved to a target image (for example, a first image, that is, an image to be generated). The present application does not limit a specific entity of the target object. In some scenes, the target object may be a person, an animal, an object, or the like.

The exclusive feature of the target object may be, for example, one or some specific features or attributes of the target object that may be used to distinguish the target object from other objects. These features or attributes are unique to the target object, and they may be clearly distinguished even between similar objects. Exemplarily, if the target object is a face, the exclusive feature information of the target object may include a color and a shape of eyes, a shape of nose, a scar, a mole, or the like. If the target object is an animal, the exclusive feature information of the target object may include a color of fur, spots, stripes, body type, or the like. If the target object is an object, the exclusive feature information of the target object may include a shape, a size, a material, a surface texture, or the like.

When the feature extraction network is configured using different parameters, the feature extraction network may focus on different image regions or feature types during a feature extraction process. For example, if the object is a face, with some parameter configurations, the feature extraction network may focus on extraction of geometric features of the face; while with some other parameter configurations, the feature extraction network may focus on extraction of skin texture features of the face.

In practice, different objects often have a relatively large individual difference, and therefore a feature extraction network adapted to the objects is required to perform feature extraction. The parameter prediction network is configured to predict which parameter should be used to configure the feature extraction network, if a feature of the target object needs to be preserved to the target image, so that the extracted feature may fully reflect the characteristics of the target object.

S120: configuring, using the target parameter, a parameter in the feature extraction network.

S130: extracting, using the configured feature extraction network, the feature of the target object from the original image.

The target parameter used to configure the feature extraction network corresponds to the target object, and this means that the configured feature extraction network is highly suitable for extracting the feature of the target object in the original image.

S140: performing, using the noise reduction network and based on the feature of the target object in the original image, denoising processing on a preset noise image to obtain a target image, where the target image includes a derived object, and an exclusive feature of the derived object is consistent with the exclusive feature of the target object.

The preset noise image may be, for example, a noise image specified in advance.

This step is essentially to use the feature of the target object in the original image to affect a denoising process of the preset noise image, so that the derived object in the target image is highly similar to the target object in the original image, and the derived object in the target image and the target object in the original image may be regarded as the same object to some extent. In other words, the derived object maintains the exclusive feature of the target object.

According to the above technical solution, the parameter prediction network is used to determine, based on the original image, the target parameter corresponding to the target object in the original image; the parameter in the feature extraction network is configured using the target parameter; the feature of the target object is extracted from the original image using the configured feature extraction network; and the noise reduction network is used to perform, based on the feature of the target object in the original image, denoising processing on the preset noise image to obtain the target image, where the target image includes the derived object, and the exclusive feature of the derived object is consistent with the exclusive feature of the target object. In essence, when the derived object in an image that needs to be generated needs to maintain the exclusive feature of the target object in the original image, instead of training an exclusive feature extraction network for the target object, a parameter that matches the target object and that is used to configure the feature extraction network is directly predicted, and the feature extraction network is configured using the parameter. Because the technical solution provided in the present application does not require training of the feature extraction network, there is no problem that the training process takes a long time, and performance requirements for a device may also be reduced, which may promote the application and promotion of the exclusive feature preservation technology (especially the portrait preservation technology).

It should be noted that in practice, the feature of the target object extracted from the original image may include an exclusive feature and a general feature of the target object.

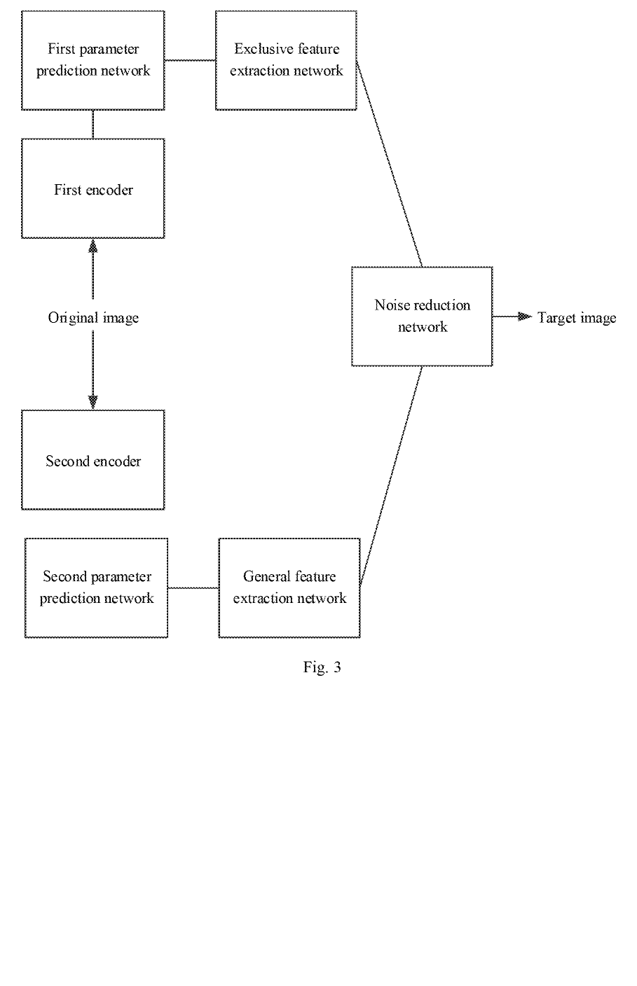

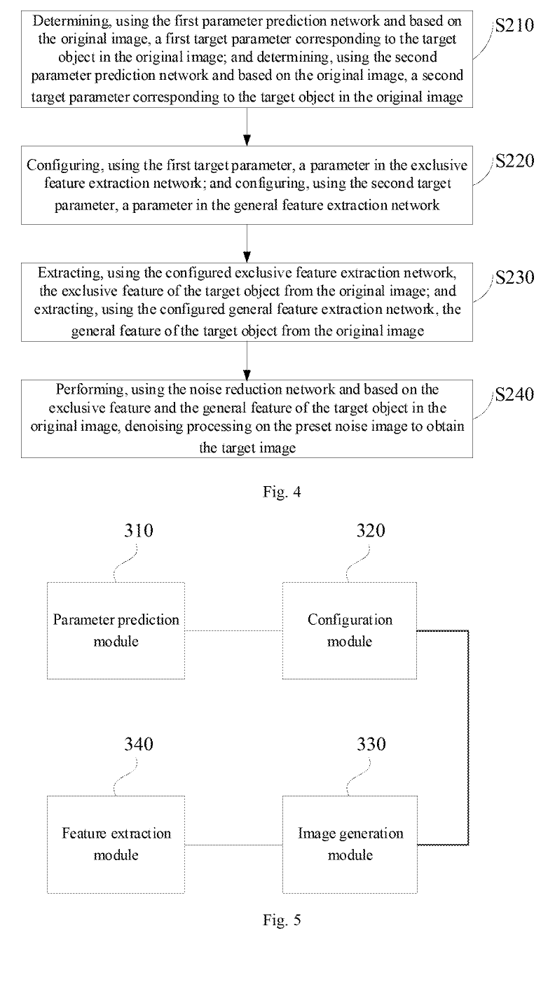

Further, based on the above technical solution, FIG. 3 is a schematic diagram of an image generation model according to an embodiment of the present disclosure. FIG. 4 is a flowchart of a method of image generation according to an embodiment of the present disclosure. Referring to FIG. 3, in the image generation model, the parameter prediction network includes a first parameter prediction network and a second parameter prediction network; the feature extraction network includes an exclusive feature extraction network and a general feature extraction network; the first parameter prediction network is connected to the exclusive feature extraction network; the second parameter prediction network is connected to the general feature extraction network; and both the exclusive feature extraction network and the general feature extraction network are connected to the noise reduction network.

S210: determining, using the first parameter prediction network and based on the original image, a first target parameter (a first sub-parameter) corresponding to the target object in the original image; and determining, using the second parameter prediction network and based on the original image, a second target parameter (for example, a second sub-parameter) corresponding to the target object in the original image.

S220: configuring, using the first target parameter, a parameter in the exclusive feature extraction network; and configuring, using the second target parameter, a parameter in the general feature extraction network.

S230: extracting, using the configured exclusive feature extraction network, the exclusive feature of the target object from the original image; and extracting, using the configured general feature extraction network, the general feature of the target object from the original image.

S240: performing, using the noise reduction network and based on the exclusive feature and the general feature of the target object in the original image, denoising processing on the preset noise image to obtain the target image.

The exclusive feature is a key factor used to distinguish different objects or individuals. The general feature is often a feature shared by different objects or individuals. Taking the target object being a person as an example, by extracting the exclusive feature, it may be ensured that the target image may still maintain identity features of the person after denoising, so that the portrait may still be accurately identified after various processing. The general feature is shared by most objects (such as a crowd) of the same type, such as a basic layout of facial features and facial symmetry.

The general feature helps to shape an overall image of the target object, and the exclusive feature is mainly used to improve the distinguishability of the target object. The technical solution is essentially to extract both the exclusive feature and the general feature when extracting the feature of the target object, so that the generated derived object is reasonable and distinguishable, thereby achieving a purpose that the derived object and the target object are regarded as the same object.

The first parameter prediction network is used to determine, based on the original image, the first target parameter corresponding to the target object in the original image; the second parameter prediction network is used to determine, based on the original image, the second target parameter corresponding to the target object in the original image; the first target parameter is used to configure the parameter in the exclusive feature extraction network; the second target parameter is used to configure the parameter in the general feature extraction network; the configured exclusive feature extraction network is used to extract the exclusive feature of the target object from the original image; and the configured general feature extraction network is used to extract the general feature of the target object from the original image. This is essentially to separately extract and separately process the general feature and the exclusive feature of the original image, which helps to highlight the exclusive feature during the denoising process, and avoid the exclusive feature being mixed with the general feature and being masked by the general feature, which leads to a poor phenomenon of low distinguishability of the derived object in the target image.

Based on the above technical solution, optionally, the image generation model further includes a first encoder, and the first encoder is connected to the first parameter prediction network; S210 may include: encoding, using the first encoder, the original image to obtain a first encoding result of the original image; and determining, using the first parameter prediction network and based on the first encoding result of the original image, the first target parameter corresponding to the original image and a first feature of the target object; and S230 may include: extracting, using the configured exclusive feature extraction network, the exclusive feature of the target object from the first feature of the target object. The first feature of the target object is an image feature related to the target object in the first encoding result of the original image. This setting is essentially to use the first encoder to encode the original image before inputting the original image into the first parameter prediction network, and the first feature of the target object is transmitted to the exclusive feature extraction network through the first parameter prediction network. In practice, the first parameter prediction network and the exclusive feature extraction network usually cannot directly process the original image, and the original image needs to be encoded. In this manner, only one first encoder is provided, instead of configuring independent encoders for the first parameter prediction network and the exclusive feature extraction network, respectively. In this manner, image processing requirements of both the first parameter prediction network and the exclusive feature extraction network may be satisfied, and the architecture of the image generation model may be simplified.

Similarly, the image generation model further includes a second encoder, and the second encoder is connected to the second parameter prediction network; S210 may include: encoding, using the second encoder, the original image to obtain a second encoding result of the original image; and determining, using the second parameter prediction network and based on the second encoding result of the original image, the second target parameter corresponding to the original image and a second feature of the target object; and S230 may include: extracting, using the configured general feature extraction network, the general feature of the target object from the second feature of the target object. The second feature of the target object is an image feature related to the target object in the second encoding result of the original image. Before the original image is input into the second parameter prediction network, the second encoder is used to encode the original image, and the second feature of the target object is transmitted to the general feature extraction network through the second parameter prediction network. In this manner, only one second encoder is provided, instead of configuring independent encoders for the second parameter prediction network and the general feature extraction network, respectively. In this manner, image processing requirements of both the second parameter prediction network and the general feature extraction network may be satisfied, and the architecture of the image generation model may be simplified.

Based on the above technical solutions, optionally, the training process of the image generation model includes a first stage and a second stage, and a method for training the image generation model includes: training, in the first stage, the second parameter prediction network, so that the second parameter prediction network has a capability of predicting a parameter applicable to the general feature extraction network; and training, in the second stage, the first parameter prediction network, so that the first parameter prediction network has a capability of predicting a parameter applicable to the exclusive feature extraction network.

Further, the training, in the first stage, the second parameter prediction network, so that the second parameter prediction network has a capability of predicting a parameter applicable to the general feature extraction network includes: obtaining a sample image pair, where the sample image pair includes a first sample image and a second sample image, and a difference between the first sample image and the second sample image is that the first sample image lacks a sample target object (for example, a first sample object) and the second sample image includes the sample target object; and training, in the first stage and based on the sample image pair, the second parameter prediction network, so that the second parameter prediction network has the capability of predicting the parameter applicable to the general feature extraction network.

Exemplarily, if an image generation model is trained and expected to have a portrait preservation function, the target object may be set to a face, the second sample image may be set to an image including a complete portrait, and the first sample image may be set to an image in which the face of the person in the second sample image is occluded.

Further, the training, in the second stage, the first parameter prediction network, so that the first parameter prediction network has a capability of predicting a parameter applicable to the exclusive feature extraction network includes: obtaining, in the second stage, a third sample image and a fourth sample image, where the third sample image and the fourth sample image each include a sample object; obtaining, based on the third sample image, a sample text corresponding to the third sample image, where the sample text is used to describe the third sample image; training, based on the third sample image and the sample text, the first parameter prediction network to determine a parameter in a text-related cross-attention module in the first parameter prediction network; and keeping the parameter in the text-related cross-attention module in the first parameter prediction network fixed, and training, based on the fourth sample image, the first parameter prediction network to determine a parameter in an image-related cross-attention module in the first parameter prediction network.

The sample object pair is an object that needs to be preserved, which is used to simulate the target object in the usage stage of the image generation model. The sample object in the third sample image and the sample object in the fourth sample image may be the same sample object, or may be different sample objects.

The first parameter prediction network includes two cross-attention modules: a text-related cross-attention module and an image-related cross-attention module. The text-related cross-attention module is related to text. The text-related cross-attention module is configured to interpret a description of a feature of an object expected to be preserved by the text, and convert the description into a guidance for image feature extraction. The image-related cross-attention module is related to an image. The image-related cross-attention module is configured to screen image features and capture local associations to supplement details.

It should be noted that whether the training is performed in the first stage or the second stage, a specific network (such as the first parameter prediction network or the second parameter prediction network) is not separately trained, instead, the entire image generation model is trained. During the training process, a loss function is determined in an image domain, that is, a parameter in the first parameter prediction network or the second parameter prediction network is adjusted by comparing a difference between an object in a prediction image output by the image generation model and an object in the input image. During the parameter adjustment process, a parameter in the denoising model is kept frozen.

According to the above technical solution, the first parameter prediction network and the second parameter prediction network are separately trained, which is beneficial to achieving a fast convergence of the image generation model and reducing the time required for training the image generation model.

It may be understood that before the technical solutions disclosed in the embodiments of the present disclosure are used, the user should be informed of the type, range of use, use scenarios, etc., of personal information involved in the present disclosure in an appropriate manner in accordance with relevant laws and regulations, and the authorization of the user should be obtained.

For example, in response to reception of an active request from a user, prompt information is sent to the user to clearly prompt the user that the requested operation will require access to and use of personal information of the user. In this manner, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. In addition, the pop-up window may also include a selection control for the user to choose whether to "agree" or "disagree" to provide the personal information to the electronic device.

It may be understood that the above process of notifying and obtaining user authorization is only illustrative, and does not limit the implementations of the present disclosure. Other manners that satisfy the relevant laws and regulations may also be applied to the implementations of the present disclosure.

It should be noted that for ease of description, the foregoing method embodiments are expressed as a series of action combinations. However, those skilled in the art should know that the present invention is not limited by the described order of actions, because some steps may be performed in other order or simultaneously according to the present invention. Secondly, those skilled in the art should also know that the embodiments described in the specification are all preferred embodiments, and the actions and modules involved are not necessarily required by the present invention.

FIG. 5 is a schematic diagram of a structure of an apparatus of image generation according to an embodiment of the present disclosure. The apparatus of image generation provided in this embodiment of the present disclosure may be configured in a client or a server. An image generation model used to implement the apparatus of image generation includes a parameter prediction network, a feature extraction network, and a noise reduction network, both the parameter prediction network and the noise reduction network are connected to the feature extraction network. Referring to FIG. 5, the apparatus of image generation specifically includes:

a parameter prediction module 310, configured to determine, using the parameter prediction network and based on an original image, a target parameter corresponding to a target object in the original image, where the original image includes the target object;

a configuration module 320, configured to configure, using the target parameter, a parameter in the feature extraction network;

a feature extraction module 330, configured to extract, using the configured feature extraction network, a feature of the target object from the original image; and

an image generation module 340, configured to perform, using the noise reduction network and based on the feature of the target object in the original image, denoising processing on a preset noise image to obtain a target image, where the target image includes a derived object, and an exclusive feature of the derived object is consistent with an exclusive feature of the target object.

Further, the parameter prediction network includes a first parameter prediction network and a second parameter prediction network; the feature extraction network includes an exclusive feature extraction network and a general feature extraction network; the first parameter prediction network is connected to the exclusive feature extraction network; the second parameter prediction network is connected to the general feature extraction network; and the exclusive feature extraction network and the general feature extraction network are further connected to the noise reduction network;

the parameter prediction module 310 is configured to: determine, using the first parameter prediction network and based on an original image, a first target parameter corresponding to a target object in the original image; and determine, using the second parameter prediction network and based on the original image, a second target parameter corresponding to the target object in the original image;

the configuration module 320 is configured to: configure, using the first target parameter, a parameter in the exclusive feature extraction network; and configure, using the second target parameter, a parameter in the general feature extraction network;

the feature extraction module 330 is configured to: extract, using the configured exclusive feature extraction network, an exclusive feature of the target object from the original image; and extract, using the configured general feature extraction network, a general feature of the target object from the original image; and

the image generation module 340 is configured to: perform, using the noise reduction network and based on the exclusive feature and the general feature of the target object in the original image, denoising processing on a preset noise image to obtain a target image.

Further, the image generation model further includes a first encoder, and the first encoder is connected to the first parameter prediction network;

the parameter prediction module 310 is configured to:

encode, using the first encoder, the original image to obtain a first encoding result of the original image; and

determine, using the first parameter prediction network and based on the first encoding result of the original image, the first target parameter corresponding to the original image and a first feature of the target object; and

the feature extraction module 330 is configured to:

extract, using the configured exclusive feature extraction network, the exclusive feature of the target object from the first feature of the target object.

Further, the image generation model further includes a second encoder, and the second encoder is connected to the second parameter prediction network;

the parameter prediction module 310 is configured to:

encode, using the second encoder, the original image to obtain a second encoding result of the original image; and

determine, using the second parameter prediction network and based on the second encoding result of the original image, the second target parameter corresponding to the original image and a second feature of the target object; and

the feature extraction module 330 is configured to:

extract, using the configured general feature extraction network, the general feature of the target object from the second feature of the target object.

Further, the training process of the image generation model includes a first stage and a second stage, and the apparatus further includes a training module configured to:

train, in the first stage, the second parameter prediction network, so that the second parameter prediction network has a capability of predicting a parameter applicable to the general feature extraction network; and

train, in the second stage, the first parameter prediction network, so that the first parameter prediction network has a capability of predicting a parameter applicable to the exclusive feature extraction network.

Further, the training module is configured to:

the training, in the first stage, the second parameter prediction network, so that the second parameter prediction network has a capability of predicting a parameter applicable to the general feature extraction network includes:

obtaining a sample image pair, where the sample image pair includes a first sample image and a second sample image, and a difference between the first sample image and the second sample image is that the first sample image lacks a sample target object and the second sample image includes the sample target object; and

training, in the first stage and based on the sample image pair, the second parameter prediction network, so that the second parameter prediction network has the capability of predicting the parameter applicable to the general feature extraction network.

Further, the training module is configured to:

obtain, in the second stage, a third sample image and a fourth sample image, where the third sample image and the fourth sample image each include a sample object;

obtain, based on the third sample image, a sample text corresponding to the third sample image, where the sample text is used to describe the third sample image;

train, based on the third sample image and the sample text, the first parameter prediction network to determine a parameter in a text-related cross-attention module in the first parameter prediction network; and

keep the parameter in the text-related cross-attention module in the first parameter prediction network fixed, and train, based on the fourth sample image, the first parameter prediction network to determine a parameter in an image-related cross-attention module in the first parameter prediction network.

The apparatus of image generation provided in this embodiment of the present disclosure may perform the steps performed by the client or the server in the method of image generation provided in the method embodiment of the present disclosure, and has the steps and beneficial effects performed, which are not repeated herein.

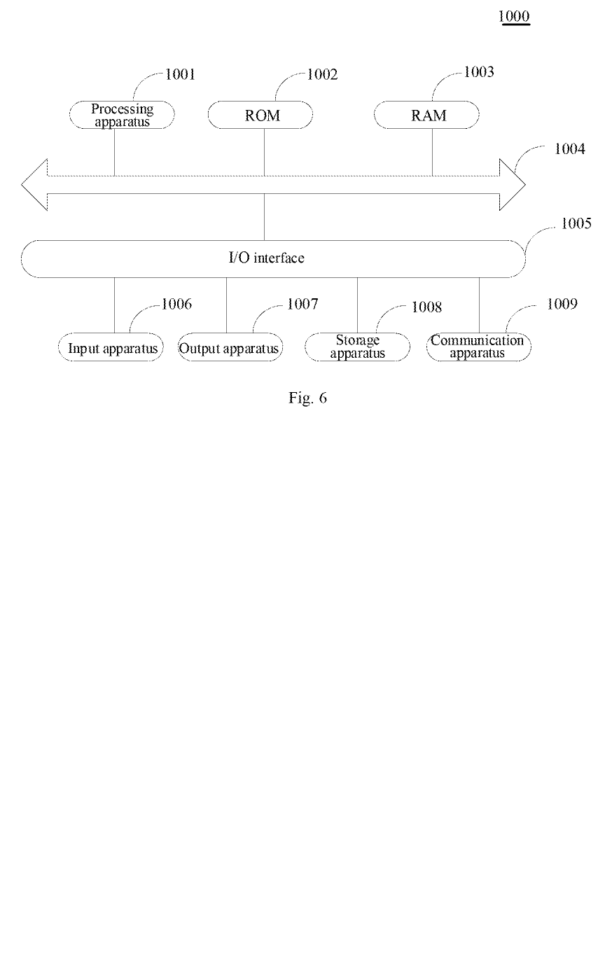

FIG. 6 is a schematic diagram of a structure of an electronic device according to an embodiment of the present disclosure. Reference is made specifically to FIG. 6 below, which is a schematic diagram of a structure of an electronic device 1000 suitable for implementing the embodiments of the present disclosure. The electronic device 1000 in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), a vehicle-mounted terminal (such as a vehicle-mounted navigation terminal), and a wearable electronic device, and fixed terminals such as a digital TV, a desktop computer, and a smart home device. The electronic device shown in FIG. 6 is merely an example, and should not impose any limitation on the function and scope of use of the embodiments of the present disclosure.

As shown in FIG. 6, the electronic device 1000 may include a processing apparatus (such as a central processing unit and a graphics processing unit) 1001 that may perform various appropriate actions and processing according to a program stored in a read-only memory (ROM) 1002 or a program loaded from a storage apparatus 1008 into a random access memory (RAM) 1003 to implement the method of image generation of the embodiments as described in the present disclosure. The RAM 1003 further stores various programs and information required for the operation of the electronic device 1000. The processing apparatus 1001, the ROM 1002, and the RAM 1003 are connected to each other through a bus 1004. An input/output (I/O) interface 1005 is also connected to the bus 1004.

Usually, the following apparatus may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a loudspeaker, and a vibrator; a storage apparatus 1008 including, for example, a magnetic tape and a hard disk; and a communication apparatus 1009. The communication apparatus 1009 may allow the electronic device 1000 to perform wireless or wired communication with other devices to exchange information. Although FIG. 6 shows the electronic device 1000 having various apparatuses, it should be understood that it is not required to implement or have all of the shown apparatuses. Alternatively, more or fewer apparatuses may be implemented or provided.

In particular, according to the embodiments of the present disclosure, the process described above with reference to the flowchart may be implemented as a computer software program. For example, this embodiment of the present disclosure includes a computer program product, which includes a computer program carried by a non-transitory computer-readable medium, where the computer program includes program code for performing the method shown in the flowchart, thereby implementing the method of image generation as described above. In such an embodiment, the computer program may be downloaded and installed from a network through the communication apparatus 1009, or installed from the storage apparatus 1008, or installed from the ROM 1002. When the computer program is executed by the processing apparatus 1001, the foregoing functions defined in the method of the embodiments of the present disclosure are performed.

It should be noted that the foregoing computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or used in combination with an instruction execution system, apparatus, or device. In the present disclosure, the computer-readable signal medium may include an information signal propagated on a baseband or as a part of a carrier, and computer-readable program code is carried in the information signal. The information signal propagated in this manner may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program code contained in the computer-readable medium may be transmitted in any suitable medium, including but not limited to a wire, an optical cable, a radio frequency (RF), or any suitable combination thereof.

In some implementations, the client and the server may communicate using any known or future developed network protocol, such as the hypertext transfer protocol (HTTP), and may be interconnected with any form or medium of digital information communication (for example, a communication network). Examples of the communication network include a local area network ("LAN"), a wide area network ("WAN"), an internet (for example, the Internet), a peer-to-peer network (for example, an Ad-Hoc network), and any network known or to be developed in the future.

The computer-readable medium may be included in the electronic device or may exist alone without being assembled into the electronic device.

The computer-readable medium carries one or more programs, and when the one or more programs are executed by the electronic device, the electronic device:

determines, using the parameter prediction network and based on an original image, a target parameter corresponding to a target object in the original image;

configures, using the target parameter, a parameter in the feature extraction network;

extracts, using the configured feature extraction network, a feature of the target object from the original image; and

performs, using the noise reduction network and based on the feature of the target object in the original image, denoising processing on a preset noise image to obtain a target image, where the target image includes a derived object, and an exclusive feature of the derived object is consistent with an exclusive feature of the target object.

Optionally, when the one or more programs are executed by the electronic device, the electronic device may further perform the other steps described in the above embodiments.

The computer program code for performing the operations of the present disclosure may be written in one or more programming languages or a combination thereof, where the programming languages include but are not limited to object-oriented programming languages such as Java, Smalltalk, and C++, and further include conventional procedural programming languages such as "C" language or similar programming languages. The program code may be completely executed on a user computer, partially executed on a user computer, executed as an independent software package, partially executed on a user computer and partially executed on a remote computer, or completely executed on a remote computer or a server. In the case of involving a remote computer, the remote computer may be connected to the user computer through any kind of network, including a local area network (LAN) or a wide area network (WAN), or may be connected to an external computer (for example, connected through the Internet using an Internet service provider).

The flowchart and block diagrams in the drawings illustrate the architecture, functionality, and operation of possible implementations of the systems, methods and computer program products according to various embodiments of the present disclosure. In this regard, each block in the flowchart or block diagrams may represent a module, program segment, or portion of code, which includes one or more executable instructions for implementing the specified logical function(s). It should also be noted that, in some alternative implementations, the functions noted in the block may occur in an order different from that noted in the drawings. For example, two blocks shown in succession may, in fact, be executed substantially concurrently, or the blocks may sometimes be executed in a reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions.

The units involved in the embodiments described in the present disclosure may be implemented in a form of software or hardware. The name of the unit does not constitute a limitation on the unit itself in some cases.

The functions described herein above may be performed, at least in part, by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electrical, magnetic, optical, electromagnetic, infrared, or semiconductor system, apparatus, or device, or any suitable combination thereof. More specific examples of the machine-readable storage medium may include an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, the present disclosure provides an electronic device, including:

one or more processors;

a memory configured to store one or more programs,

when the one or more programs are executed by the one or more processors, the one or more processors are caused to implement the method of image generation as described in any one of the implementations provided in the present disclosure.

According to one or more embodiments of the present disclosure, the present disclosure provides a computer-readable storage medium having a computer program stored thereon, and when the program is executed by a processor, the method of image generation as described in any one of the implementations provided in the present disclosure is implemented.

An embodiment of the present disclosure further provides a computer program product, where the computer program product includes a computer program or instructions, and when the computer program or instructions are executed by a processor, the method of image generation as described above is implemented.

It should be noted that in this specification, relational terms such as "first" and "second" are used solely to distinguish one entity or action from another entity or action without necessarily requiring or implying any actual such relationship or order between such entities or actions. Moreover, the terms "include", "comprise", or any other variation thereof are intended to cover non-exclusive inclusion, such that a process, method, object, or device including a list of elements includes not only those elements, but also other elements not expressly listed or elements inherent to such process, method, object, or device. Without further limitation, an element defined by the phrase "includes a" does not exclude the presence of additional identical elements in the process, method, object, or device that includes the element.

The foregoing descriptions are merely specific implementations of the present disclosure, so that those skilled in the art may understand or implement the present disclosure. Various modifications to these embodiments will be readily apparent to those skilled in the art, and the generic principles defined herein may be implemented in other embodiments without departing from the spirit or scope of the present disclosure. Therefore, the present disclosure will not be limited to the embodiments described herein, but is to be accorded the widest scope consistent with the principles and novel features disclosed herein.

1. A method of image generation, wherein an image generation model used to implement the method of image generation comprises a parameter prediction network, a feature extraction network, and a noise reduction network, both the parameter prediction network and the noise reduction network are connected to the feature extraction network, and the method comprises:
determining, using the parameter prediction network and based on an original image, a first parameter corresponding to a first object in the original image;
configuring, using the first parameter, a parameter in the feature extraction network;
extracting, using the configured feature extraction network, a feature of the first object from the original image; and
performing, using the noise reduction network and based on the feature of the first object in the original image, denoising processing on a preset noise image to obtain a first image, wherein the first image comprises a derived object, and an exclusive feature of the derived object is consistent with an exclusive feature of the first object.

2. The method of claim 1, wherein the parameter prediction network comprises a first parameter prediction network and a second parameter prediction network; the feature extraction network comprises an exclusive feature extraction network and a general feature extraction network; the first parameter prediction network is connected to the exclusive feature extraction network; the second parameter prediction network is connected to the general feature extraction network; and the exclusive feature extraction network and the general feature extraction network are further connected to the noise reduction network;
the determining, using the parameter prediction network and based on an original image, a first parameter corresponding to a first object in the original image comprises: determining, using the first parameter prediction network and based on an original image, a first sub-parameter corresponding to the first object in the original image; and determining, using the second parameter prediction network and based on the original image, a second sub-parameter corresponding to the first object in the original image;
the configuring, using the first parameter, a parameter in the feature extraction network comprises: configuring, using the first sub-parameter, a parameter in the exclusive feature extraction network; and configuring, using the second sub-parameter, a parameter in the general feature extraction network;
the extracting, using the configured feature extraction network, a feature of the first object from the original image comprises: extracting, using the configured exclusive feature extraction network, an exclusive feature of the first object from the original image; and extracting, using the configured general feature extraction network, a general feature of the first object from the original image; and
the performing, using the noise reduction network and based on the feature of the first object in the original image, denoising processing on a preset noise image to obtain a first image comprises: performing, using the noise reduction network and based on the exclusive feature and the general feature of the first object in the original image, denoising processing on a preset noise image to obtain a first image.

3. The method of claim 2, wherein the image generation model further comprises a first encoder, and the first encoder is connected to the first parameter prediction network;
the determining, using the first parameter prediction network and based on an original image, a first sub-parameter corresponding to the original image comprises:
encoding, using the first encoder, the original image to obtain a first encoding result of the original image; and
determining, using the first parameter prediction network and based on the first encoding result of the original image, the first sub-parameter corresponding to the original image and a first feature of the first object; and
the extracting, using the configured exclusive feature extraction network, an exclusive feature of the first object from the original image comprises:
extracting, using the configured exclusive feature extraction network, the exclusive feature of the first object from the first feature of the first object.

4. The method of claim 3, wherein the image generation model further comprises a second encoder, and the second encoder is connected to the second parameter prediction network;
the determining, using the second parameter prediction network and based on an original image, a second sub-parameter corresponding to the original image comprises:
encoding, using the second encoder, the original image to obtain a second encoding result of the original image; and
determining, using the second parameter prediction network and based on the second encoding result of the original image, the second sub-parameter corresponding to the original image and a second feature of the first object; and
the extracting, using the configured general feature extraction network, a general feature of the first object from the original image comprises:
extracting, using the configured general feature extraction network, the general feature of the first object from the second feature of the first object.

5. The method of claim 4, wherein a training process of the image generation model comprises a first stage and a second stage, and the method for training the image generation model comprises:
training, in the first stage, the second parameter prediction network, so that the second parameter prediction network has a capability of predicting a parameter applicable to the general feature extraction network; and
training, in the second stage, the first parameter prediction network, so that the first parameter prediction network has a capability of predicting a parameter applicable to the exclusive feature extraction network.

6. The method of claim 5, wherein the training, in the first stage, the second parameter prediction network, so that the second parameter prediction network has a capability of predicting a parameter applicable to the general feature extraction network comprises:
obtaining a sample image pair, wherein the sample image pair comprises a first sample image and a second sample image, and a difference between the first sample image and the second sample image is that the first sample image lacks a first sample object and the second sample image comprises the first sample object; and
training, in the first stage and based on the sample image pair, the second parameter prediction network, so that the second parameter prediction network has the capability of predicting the parameter applicable to the general feature extraction network.

7. The method of claim 6, wherein the training, in the second stage, the first parameter prediction network, so that the first parameter prediction network has a capability of predicting a parameter applicable to the exclusive feature extraction network comprises:
obtaining a third sample image and a fourth sample image, wherein the third sample image and the fourth sample image each comprise a sample object;
obtaining, based on the third sample image, a sample text corresponding to the third sample image, wherein the sample text is used to describe the third sample image;
training, based on the third sample image and the sample text, the first parameter prediction network to determine a parameter in a text-related cross-attention module in the first parameter prediction network; and
keeping the parameter in the text-related cross-attention module in the first parameter prediction network fixed, and training, based on the fourth sample image, the first parameter prediction network to determine a parameter in an image-related cross-attention module in the first parameter prediction network.

8. An electronic device, wherein the electronic device comprises:
one or more processors;
at least one memory, configured to store one or more programs; wherein
when the one or more programs are executed by the one or more processors, the one or more processors are caused to implement a method of image generation, wherein an image generation model used to implement the method of image generation comprises a parameter prediction network, a feature extraction network, and a noise reduction network, both the parameter prediction network and the noise reduction network are connected to the feature extraction network, and the method comprises:
determining, using the parameter prediction network and based on an original image, a first parameter corresponding to a first object in the original image;
configuring, using the first parameter, a parameter in the feature extraction network;
extracting, using the configured feature extraction network, a feature of the first object from the original image; and
performing, using the noise reduction network and based on the feature of the first object in the original image, denoising processing on a preset noise image to obtain a first image, wherein the first image comprises a derived object, and an exclusive feature of the derived object is consistent with an exclusive feature of the first object.

9. The electronic device of claim 8, wherein the parameter prediction network comprises a first parameter prediction network and a second parameter prediction network; the feature extraction network comprises an exclusive feature extraction network and a general feature extraction network; the first parameter prediction network is connected to the exclusive feature extraction network; the second parameter prediction network is connected to the general feature extraction network; and the exclusive feature extraction network and the general feature extraction network are further connected to the noise reduction network;
the determining, using the parameter prediction network and based on an original image, a first parameter corresponding to a first object in the original image comprises: determining, using the first parameter prediction network and based on an original image, a first sub-parameter corresponding to the first object in the original image; and determining, using the second parameter prediction network and based on the original image, a second sub-parameter corresponding to the first object in the original image;
the configuring, using the first parameter, a parameter in the feature extraction network comprises: configuring, using the first sub-parameter, a parameter in the exclusive feature extraction network; and configuring, using the second sub-parameter, a parameter in the general feature extraction network;
the extracting, using the configured feature extraction network, a feature of the first object from the original image comprises: extracting, using the configured exclusive feature extraction network, an exclusive feature of the first object from the original image; and extracting, using the configured general feature extraction network, a general feature of the first object from the original image; and
the performing, using the noise reduction network and based on the feature of the first object in the original image, denoising processing on a preset noise image to obtain a first image comprises: performing, using the noise reduction network and based on the exclusive feature and the general feature of the first object in the original image, denoising processing on a preset noise image to obtain a first image.

10. The electronic device of claim 9, wherein the image generation model further comprises a first encoder, and the first encoder is connected to the first parameter prediction network;
the determining, using the first parameter prediction network and based on an original image, a first sub-parameter corresponding to the original image comprises:
encoding, using the first encoder, the original image to obtain a first encoding result of the original image; and
determining, using the first parameter prediction network and based on the first encoding result of the original image, the first sub-parameter corresponding to the original image and a first feature of the first object; and
the extracting, using the configured exclusive feature extraction network, an exclusive feature of the first object from the original image comprises:
extracting, using the configured exclusive feature extraction network, the exclusive feature of the first object from the first feature of the first object.

11. The electronic device of claim 10, wherein the image generation model further comprises a second encoder, and the second encoder is connected to the second parameter prediction network;
the determining, using the second parameter prediction network and based on an original image, a second sub-parameter corresponding to the original image comprises:
encoding, using the second encoder, the original image to obtain a second encoding result of the original image; and
determining, using the second parameter prediction network and based on the second encoding result of the original image, the second sub-parameter corresponding to the original image and a second feature of the first object; and
the extracting, using the configured general feature extraction network, a general feature of the first object from the original image comprises:
extracting, using the configured general feature extraction network, the general feature of the first object from the second feature of the first object.

12. The electronic device of claim 11, wherein a training process of the image generation model comprises a first stage and a second stage, and the method for training the image generation model comprises:
training, in the first stage, the second parameter prediction network, so that the second parameter prediction network has a capability of predicting a parameter applicable to the general feature extraction network; and
training, in the second stage, the first parameter prediction network, so that the first parameter prediction network has a capability of predicting a parameter applicable to the exclusive feature extraction network.

13. The electronic device of claim 12, wherein the training, in the first stage, the second parameter prediction network, so that the second parameter prediction network has a capability of predicting a parameter applicable to the general feature extraction network comprises:
obtaining a sample image pair, wherein the sample image pair comprises a first sample image and a second sample image, and a difference between the first sample image and the second sample image is that the first sample image lacks a first sample object and the second sample image comprises the first sample object; and
training, in the first stage and based on the sample image pair, the second parameter prediction network, so that the second parameter prediction network has the capability of predicting the parameter applicable to the general feature extraction network.

14. The electronic device of claim 13, wherein the training, in the second stage, the first parameter prediction network, so that the first parameter prediction network has a capability of predicting a parameter applicable to the exclusive feature extraction network comprises:
obtaining a third sample image and a fourth sample image, wherein the third sample image and the fourth sample image each comprise a sample object;
obtaining, based on the third sample image, a sample text corresponding to the third sample image, wherein the sample text is used to describe the third sample image;
training, based on the third sample image and the sample text, the first parameter prediction network to determine a parameter in a text-related cross-attention module in the first parameter prediction network; and
keeping the parameter in the text-related cross-attention module in the first parameter prediction network fixed, and training, based on the fourth sample image, the first parameter prediction network to determine a parameter in an image-related cross-attention module in the first parameter prediction network.

15. A non-transitory computer-readable storage medium having a computer program stored thereon, wherein when the program is executed by a processor, a method of image generation, an image generation model used to implement the method of image generation comprises a parameter prediction network, a feature extraction network, and a noise reduction network, both the parameter prediction network and the noise reduction network are connected to the feature extraction network, and the method comprises:
determining, using the parameter prediction network and based on an original image, a first parameter corresponding to a first object in the original image;
configuring, using the first parameter, a parameter in the feature extraction network;
extracting, using the configured feature extraction network, a feature of the first object from the original image; and
performing, using the noise reduction network and based on the feature of the first object in the original image, denoising processing on a preset noise image to obtain a first image, wherein the first image comprises a derived object, and an exclusive feature of the derived object is consistent with an exclusive feature of the first object .

16. The non-transitory computer-readable storage medium of claim 15, wherein the parameter prediction network comprises a first parameter prediction network and a second parameter prediction network; the feature extraction network comprises an exclusive feature extraction network and a general feature extraction network; the first parameter prediction network is connected to the exclusive feature extraction network; the second parameter prediction network is connected to the general feature extraction network; and the exclusive feature extraction network and the general feature extraction network are further connected to the noise reduction network;
the determining, using the parameter prediction network and based on an original image, a first parameter corresponding to a first object in the original image comprises: determining, using the first parameter prediction network and based on an original image, a first sub-parameter corresponding to the first object in the original image; and determining, using the second parameter prediction network and based on the original image, a second sub-parameter corresponding to the first object in the original image;
the configuring, using the first parameter, a parameter in the feature extraction network comprises: configuring, using the first sub-parameter, a parameter in the exclusive feature extraction network; and configuring, using the second sub-parameter, a parameter in the general feature extraction network;
the extracting, using the configured feature extraction network, a feature of the first object from the original image comprises: extracting, using the configured exclusive feature extraction network, an exclusive feature of the first object from the original image; and extracting, using the configured general feature extraction network, a general feature of the first object from the original image; and
the performing, using the noise reduction network and based on the feature of the first object in the original image, denoising processing on a preset noise image to obtain a first image comprises: performing, using the noise reduction network and based on the exclusive feature and the general feature of the first object in the original image, denoising processing on a preset noise image to obtain a first image.

17. The non-transitory computer-readable storage medium of claim 16, wherein the image generation model further comprises a first encoder, and the first encoder is connected to the first parameter prediction network;
the determining, using the first parameter prediction network and based on an original image, a first sub-parameter corresponding to the original image comprises:
encoding, using the first encoder, the original image to obtain a first encoding result of the original image; and
determining, using the first parameter prediction network and based on the first encoding result of the original image, the first sub-parameter corresponding to the original image and a first feature of the first object; and
the extracting, using the configured exclusive feature extraction network, an exclusive feature of the first object from the original image comprises:
extracting, using the configured exclusive feature extraction network, the exclusive feature of the first object from the first feature of the first object.

18. The non-transitory computer-readable storage medium of claim 17, wherein the image generation model further comprises a second encoder, and the second encoder is connected to the second parameter prediction network;
the determining, using the second parameter prediction network and based on an original image, a second sub-parameter corresponding to the original image comprises:
encoding, using the second encoder, the original image to obtain a second encoding result of the original image; and
determining, using the second parameter prediction network and based on the second encoding result of the original image, the second sub-parameter corresponding to the original image and a second feature of the first object; and
the extracting, using the configured general feature extraction network, a general feature of the first object from the original image comprises:
extracting, using the configured general feature extraction network, the general feature of the first object from the second feature of the first object.

19. The non-transitory computer-readable storage medium of claim 18, wherein a training process of the image generation model comprises a first stage and a second stage, and the method for training the image generation model comprises:
training, in the first stage, the second parameter prediction network, so that the second parameter prediction network has a capability of predicting a parameter applicable to the general feature extraction network; and
training, in the second stage, the first parameter prediction network, so that the first parameter prediction network has a capability of predicting a parameter applicable to the exclusive feature extraction network.

20. The non-transitory computer-readable storage medium of claim 19, wherein the training, in the first stage, the second parameter prediction network, so that the second parameter prediction network has a capability of predicting a parameter applicable to the general feature extraction network comprises:
obtaining a sample image pair, wherein the sample image pair comprises a first sample image and a second sample image, and a difference between the first sample image and the second sample image is that the first sample image lacks a first sample object and the second sample image comprises the first sample object; and
training, in the first stage and based on the sample image pair, the second parameter prediction network, so that the second parameter prediction network has the capability of predicting the parameter applicable to the general feature extraction network.
